(19) United States
(12) Patent Application Publication
(10) Pub. No.: US 2025/0208602 A1
(43) Pub. Date: Jun. 26, 2025

(54) IDENTIFICATION OF CONTROLLED OBJECTS

(71) Applicants: Peridot Print LLC, Palo Alto, CA (US); Nanyang Technological University, Singapore (SG)

(72) Inventors: Yelena Helen BALINSKY, Bristol (GB); Ihar VOLKAU, Singapore (CN)

(21) Appl. No.: 18/856,211

(22) PCT Filed: Apr. 14, 2022
(86) PCT No.: PCT/US2022/024902

§ 371 Date: Oct. 11, 2024

(51) Int. Cl. G05B 19/4099; B29C 64/386; B33Y 50/00

(52) U.S. Cl. CPC G05B 19/4099; B29C 64/386; B33Y 50/00; G05B 2219/49023

(57) ABSTRACT

A computing system for a three-dimensional printing apparatus is provided. The computing system comprises a database that stores object data for a controlled object, the object data comprising confidentiality preserving descriptors associated to the controlled object and a specification of processes for identifying the controlled object, the specification comprising a hierarchical arrangement of processes into layers, wherein processes in a given layer have a higher accuracy for identifying the controlled object than processes in a preceding layer. The computing system comprises a processor to receive a request to print a three-dimensional object on the three-dimensional printing apparatus, access object data for the controlled object from the database, determine confidentiality preserving descriptors of the three-dimensional object and evaluate processes according to the object data for the controlled object based on the confidentiality preserving descriptors of the three-dimensional object and the controlled object.

### BACKGROUND

Additive manufacturing enables the construction of three-dimensional objects from digital representations of the objects. In recent years additive manufacturing has advanced to the point that additive manufacturing processes are deployable at an industrial scale.

Additive manufacturing techniques enable the production of controlled objects (COs). COs may be counterfeit or illegal goods or goods which are subject to copyright, licensing or regulations. In recent years concerns have been raised over the proliferation of additively manufactured weapons and fake parts. In response, measures are being introduced to deter manufacturing of COs.

### BRIEF DESCRIPTION OF THE DRAWINGS

FIG. 1 is a schematic diagram showing an additive manufacturing apparatus, according to an example.

FIG. 2 is a schematic diagram showing a hierarchical identification scheme, according to an example.

FIG. 3 is a schematic diagram showing a database, according to an example.

FIG. 4 is a block diagram of a method for identifying a controlled object, according to an example.

FIG. 5 is a block diagram of a method for applying policies, according to an example.

FIG. 6 is a block diagram of a method for identifying controlled objects, according to an example.

FIG. 7 is a schematic diagram showing a processor and memory, according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

Additive manufacturing has revolutionized industry and has brought many new opportunities for individuals and businesses. In recent years concerns have been raised among legislators and industry about the proliferation of so-called controlled objects (COs). COs are objects that may be subject to legal protection, regulation or restrictions such as objects protected by intellectual property or illicit objects such as weapons.

When a potential CO is encountered in a print job, a policy or action may be applied, for example, to prevent manufacturing of the identified CO or to alert factory operators or other authorities. In order to determine whether a given object in a print job is a CO, information about COs that is available locally in a printing system at the edge of the network may be used to enable comparison of the object with known COs. Unfortunately, in this scenario, if blueprints for a CO are stored in a readily obtainable and readable format then the CO could be extracted and leaked to an attacker.

Instead of storing CO blueprints at the printer itself, the blueprints may be replaced with data representative of the CO, referred to herein as confidentiality preserving descriptors (CPDs). CPDs have the following properties: CPDs are non-reversible representations of three-dimensional objects which prevent the COs being restored or reverse engineered with any accuracy. CPDs contain essential information about the geometry of the CO in a compressed low-data and low-dimensional form. CPDs are also quick to compute and efficient to match, being discriminative and invariant to rigid transformations. Furthermore, to ensure integrity and immutability CPDs are accompanied by a digital signature. This prevents accidental or intentional corruption or modification of the CPD.

Generally, the probability of encountering a CO during a print job is relatively low. Hence, the methods described herein may be used to ensure that productivity & throughput are not significantly impacted by the task of checking whether a given object is a CO.

The methods and system described herein provide a Multi-Layered System (MLS) framework for filtering out non-COs in an efficient manner. In particular, a system architecture for determination of multiple COs within a 3D printing system is described based on a multi-layered, hierarchical rejection/acceptance approach. The MLS may be optimized for each individual CO. Each layer of the MLS comprises a parallelizable set of determination/rejection processes which use CPDs to compare an object to CPDs of COs in a database. The accuracy of the determination/rejection processes increases from one layer to the next layer from fast rejection processes on initial layers to accurate determination but more computationally expensive processes on the latter layers. Processes on the same layer are of similar criticality and computational complexity. A decision whether to progress to the next layer is based on results of all processes on the current layer.

Some types of CPDs such as simple feature based CPDs enable rapid computation and rejection. For examples CPDs based on the computation of the volume of objects or object genus are relatively quick to compute. Other types of CPDs are more fine-grained and enable positive determination such as those based on Spherical Harmonic Transformation (SHT) or extended Gaussian images.

In addition to the MLS framework, a configurable strategy to define a subset of processes and related CPDs on each layer which are relevant and optimal for determination of a particular CO is provided. This allows omission of irrelevant or non-representative processes for a particular CO.

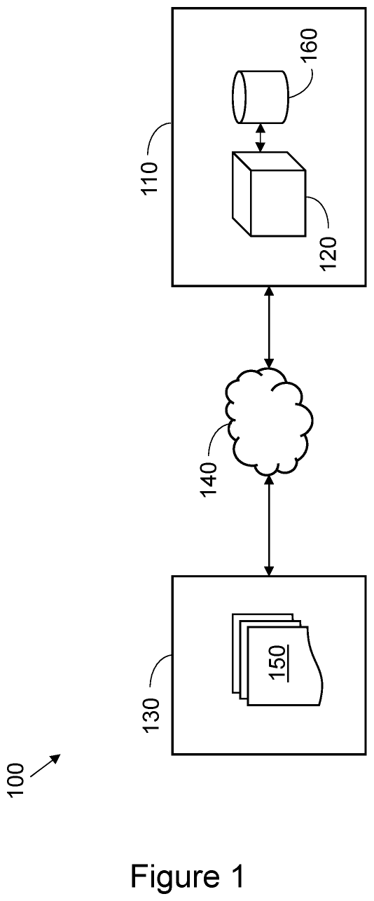

FIG. 1 is a simplified schematic diagram 100 showing an apparatus for manufacturing an object, according to an example. In FIG. 1, a manufacturing facility 110 is shown. The manufacturing facility 110 may be, for example, a factory owned by a company or the home of an end user. In FIG. 1 the manufacturing facility 110 contains at least one additive manufacturing apparatus 120. The additive manufacturing apparatus 120 may be a three-dimensional printing system. The additive manufacturing apparatus 120 receives an input or ‘print job’ comprising a representation of a three-dimensional object as a data file and generates an output comprising a printed version of the three-dimensional object.

In FIG. 1, the additive manufacturing apparatus 120 is arranged to communicate with a separate secure entity 130 via a network 140. The secure entity 130 may be arranged to generate, maintain and/or store data files 150 for one or more COs. COs may be, for example, weapons or other objects whose manufacturing might be illegal, infringe laws, authorship rights or other regulations which restrict the dissemination of the objects to third parties.

According to examples described herein, when the additive manufacturing apparatus 120 receives a data file to print an object, it first checks whether the three-dimensional object represented by the data file is a CO. The additive manufacturing apparatus 120 is communicatively coupled to a database 160. The database 160 is a secure trusted storage accessible by the additive manufacturing apparatus 120, during operations. Information relating to COs including CPDs, identification strategy and policy are stored in the database 160. The database 160 may function in an offline state after receiving updates from the secure entity 130.

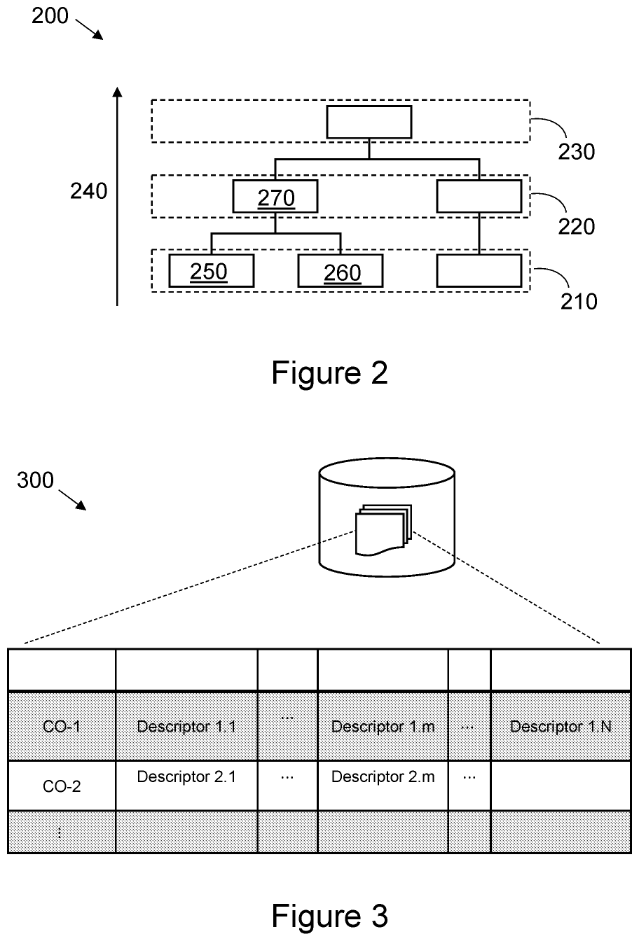

FIG. 2 shows a simplified schematic diagram of a hierarchical multi-layered system (MLS) of determination/rejection process 200, according to an example. The MLS 200 may be implemented by the additive manufacturing apparatus 120 when the additive manufacturing apparatus 120 receive a print job to print an object. Each process represented in FIG. 2 may comprise a computation of a CPD and a comparison of the CPD with a corresponding CPD of a CO in the database 160.

The example of MLS 200 comprises three layers of processes: a first layer 210, a second 220 and a third layer 230. The number of layers and the number of processes in the layers may be any number and may depend on the complexity of the analysis for a specific CO. The arrow 240 is indicative of an increasing computational complexity of the processes. The connecting lines in FIG. 2 among processes 250, 260 and 270 are indicative of passing control from processes 250, 260 to 270. Process on each layer may be executed in parallel. The process at the current level may run independently or may use information from the processes of the previous level as inputs. Outputs of processes in a given layer may indicate that the control is passed to a process in a higher layer or provide output that the object in the print job is distinct from a CO. The latter enables a rapid determination that a given object is not a CO based on an output of a lower complexity process. For example, outputs from processes 250, 260 in the first layer 210 may be used to determine whether an object is not a CO or that control is passed to the process 270 in the second layer 220. The process 270 has a higher computational complexity than any of the processes 250, 260 in the first layer 210.

FIG. 3 is a simplified schematic diagram of a database 300, according to an example. The database 160 shown in FIG. 1 may be implemented based on a database similar to the database 300 shown in FIG. 1. The database 300 comprises entries for COs. Each CO may be associated with a collection of CPDs. For example in FIG. 3, CO-1 is associated with CPDs, Descriptor 1.1, . . . , Descriptor 1.N. According to examples, Descriptor 1.1 may be a CPD computed using a simple feature such as the number of holes in the CO. As such this CPD may be associated with a low layer determination/rejection process in the hierarchy shown in FIG. 2 such as processes 250, 260, based on simple feature comparison. In contrast, Descriptor 1.N may be a CPD computed using a more sophisticated function of the CO, which is more computationally expensive. In that case, Descriptor 1.N may be associated with a higher level process in the hierarchical MLS 200.

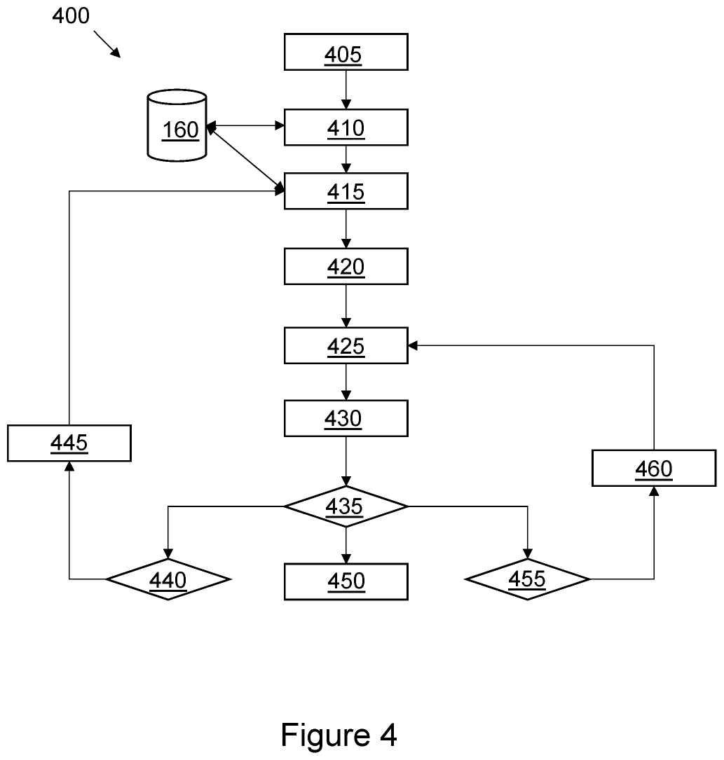

FIG. 4 is a flow diagram showing a method 400 for determining whether objects in a print job correspond to a CO, according to an example. The method 400 may be implemented on the additive manufacturing apparatus 120 shown in FIG. 1. At block 405 an object, B, is identified in a print job. According to examples, the method 400 may be repeated for each object in the print job. At block 410 a CO is selected from the database 160. At block 415 an identification strategy, S, is loaded from the database 160 together with CPDs for the CO. The strategy, S, specifies the number of layers and processes of the MLS, similar to the MLS 200 shown in FIG. 2. The strategy, S, shows which processes are assigned to each layer. In some cases, the strategy, S, also specifies ranges and acceptability thresholds for comparison of CPDs for rejection or acceptance of an object as the CO.

At block 420, the method comprises selecting a layer, L, of the MLS specified by the strategy, S. At block 425, all processes for the layer, L, are executed to determine CPDs for the object, B. At block 430, the CPDs for the object B are compared with the CPDs of the CO. At block 435, if the object B is determined to not be the same as the CO, then at block 440, it is determined whether there are more controlled objects in the database 160. If there are more controlled objects in the database 160, at block 445 the next CO is selected at the method returns to block 415. Else, if the object is determined to be the CO, then at block 450 it is reported that the object is the CO to the additive manufacturing apparatus 120. At block 455, if it is undetermined whether the object B is the CO then it is determined whether there are more layers in the MLS. If there are more layers in the MLS then the next layer is selected at block 460 and the method returns to block 425 so that the processes for the next layer are executed.

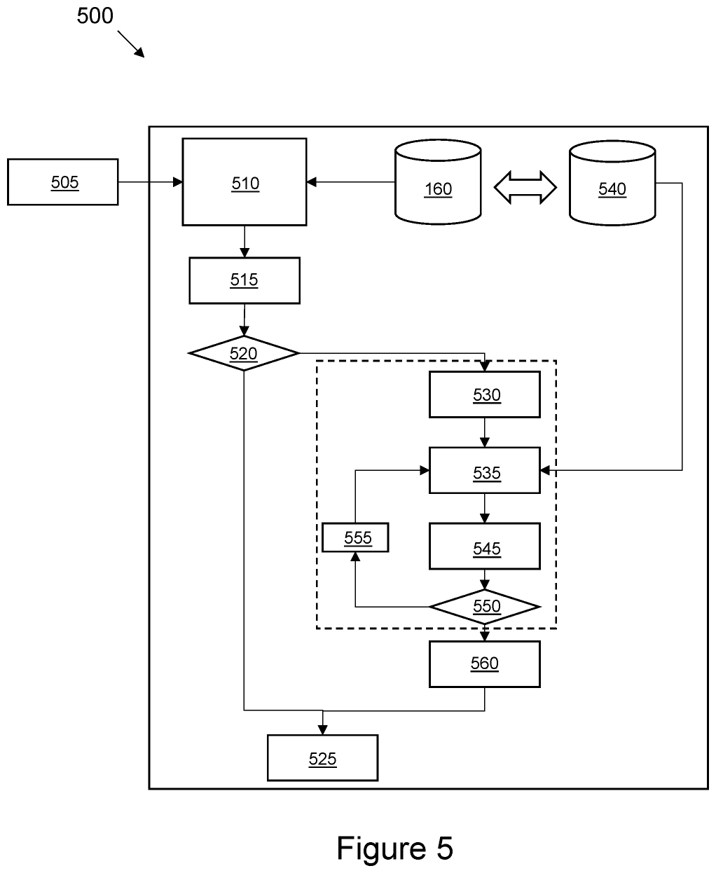

FIG. 5 is a flow diagram showing a method 500 for applying a policy prior to manufacturing of an object in a print job. The method 500 may be implemented in conjunction with the method 400 shown in FIG. 4. For each CO represented in the database a policy may be retrieved and executed. Each policy defines actions which are executed when a particular CO is encountered in a print job. Actions may include, for example, raising a notification, stop printing job, inform an authority, etc.

In FIG. 5, the block 505 represents a print job and block 510 represents the method 400 shown in FIG. 4. At block 515 a list of COs identified in the print job 505 by method 400 is generated. At block 520, if the list is empty then the print job 505 is executed, at block 525. Else, at block 530 the first object in the list is selected. At block 535 a policy is retrieved from a policy store 540. At block 545 the policy is executed. At block 550, if more objects are in the list, then the next object is selected at block 555, and block 535 is repeated for the next object. Else, at block 560 the print job is adjusted accordingly.

According to examples, authorities or copywrite owners may initiate a process of inclusion of an object as a controlled object into the database 160. The 3D description of the controlled object is processed to calculate the object's CPDs. CPDs for all or only relevant determination/rejection processes are computed. Keeping all relevant CPDs with diverse discriminative features increases robustness and accuracy of identification. In some cases, a determination of acceptability thresholds for identifying the controlled object may be made. The calculated CPDs are digitally signed by an authority, so prevent unauthorized modifications of descriptor. An identification strategy may also be determined for the object. This may include determining which processes are to be computed within each layer similar to the MLS shown in FIG. 2. A strategy may be defined by the person who inserts the CO into the database 160, or otherwise a standardised strategy may be applied by default. The identification strategy for the object may also be certified.

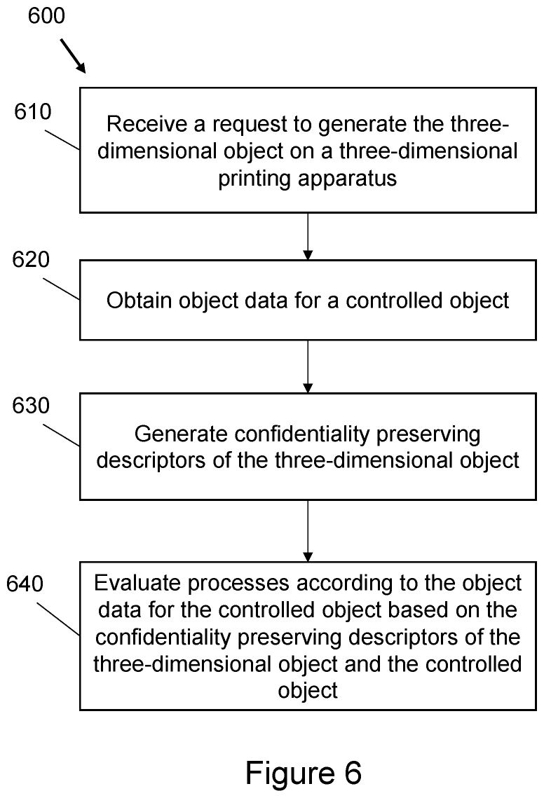

FIG. 6 is a block diagram of a method 600, for a three-dimensional printing apparatus. The method 600 may be used in conjunction with the other systems and methods described herein. At block 610 the method 600 comprises receiving a request to generate the three-dimensional object on a three-dimensional printing apparatus. At block 620 the method comprises obtaining object data for a controlled object. The object data comprises confidentiality preserving descriptors associated to the controlled object and a hierarchy of processes for identifying the controlled object. The hierarchy comprises layers of processes whereby processes in a given layer have a higher accuracy for identifying the controlled object than processes in a preceding layer. At block 630 the method 600 comprises generating confidentiality preserving descriptors of the three-dimensional object. At block 640 the method 600 comprises evaluating processes according to the object data for the controlled object based on the confidentiality preserving descriptors and the confidentiality preserving descriptors of the three-dimensional object.

The methods and systems described herein provide a Multi-Layered System (MLS) that provides parallelization in the identification of controlled objects. The determination/rejection processes on the same layer are of similar complexity and are computed simultaneously, thus efficiently utilizing available computational resources and minimizing response time. Use of multiple processes for determination of each CO provides a system with robustness and resilience against accidental or malicious modifications of design. The system provides fine-tuning for rapid rejection or rapid detection of an object as a particular CO, based on essential properties and attributes of the CO. The proposed system is easily extendable. New methods of identification and new COs can be added, when new threats are detected without re-training of the overall system. Furthermore, the system is easily customizable to be country-specific to reflect local legislation and to be fine-tuned to local threats.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus may be implemented by a processor executing machine-readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode.

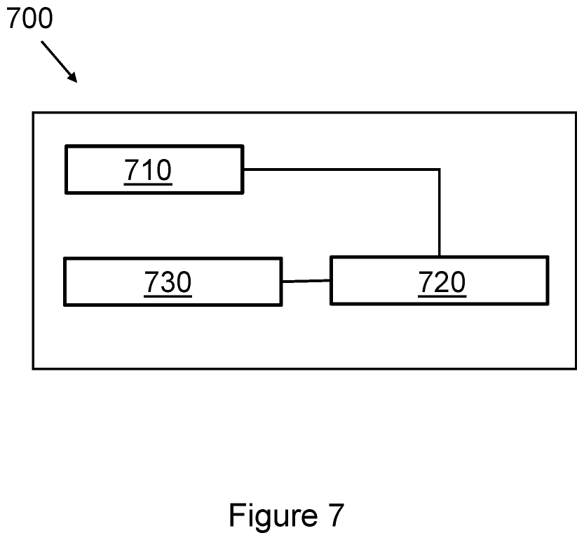

For example, the instructions may be provided on a non-transitory computer readable storage medium encoded with instructions, executable by a processor. FIG. 7 shows an example of a processor 710 associated with a memory 720. The memory 720 comprises computer readable instructions 730 which are executable by the processor 710. The instructions cause the processor to access a database that stores object data for a controlled object, the object data comprising: confidentiality preserving descriptors associated to the controlled object; and a specification of processes for identifying the controlled object, the specification comprising a hierarchical arrangement of processes into layers, wherein processes in a given layer have a higher accuracy for identifying the controlled object than processes in a preceding layer. The instructions further cause the processor to obtain an instruction to generate the three-dimensional object on the three-dimensional printing apparatus, generate confidentiality preserving descriptors of the three-dimensional object and evaluate processes according to the object data for the controlled object based on the confidentiality preserving descriptors of the three-dimensional object and the controlled object.

Such machine-readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the present disclosure. In particular, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A computing system for a three-dimensional printing apparatus, the computing system comprising:
a database that stores object data for a controlled object, the object data comprising:
confidentiality preserving descriptors associated to the controlled object; and
a specification of processes for identifying the controlled object, the specification comprising a hierarchical arrangement of processes into layers, wherein processes in a given layer have a higher accuracy for identifying the controlled object than processes in a preceding layer;
and
a processor to:
receive a request to print a three-dimensional object on the three- dimensional printing apparatus;
access object data for the controlled object from the database;
determine confidentiality preserving descriptors of the three- dimensional object; and
evaluate processes according to the object data for the controlled object based on the confidentiality preserving descriptors of the three- dimensional object and the controlled object.

2. The computing system according to claim 1, wherein, to evaluate processes according to the object data, the processor is to:
evaluate layers of the hierarchy of processes in sequence, based on an output of the evaluation of the preceding layer of processes in the hierarchy.

3. The computing system according to claim 2, wherein the processor is to:
determine that the three-dimensional object is distinct from the controlled object when the evaluation of processes in a layer of the hierarchy is indicative of a dissimilarity between the three-dimensional object and the controlled object.

4. The computing system according to claim 3, wherein the processor is to print the three-dimensional object in response to determining that the three-dimensional object is distinct from the controlled object.

5. The computing system according to claim 1, wherein processes in a first layer have a lower computational complexity than processes in a second layer, subsequent to the first layer.

6. The computing system according to claim 1, wherein the processor is to:
determine that the three-dimensional object is the same as the controlled object when evaluation of processes in all layers of the hierarchy are indicative of a similarity between the three-dimensional object and the controlled object.

7. The computing system according to claim 6, wherein the processor is to execute a policy in response to determining that the three-dimensional object is the same as the controlled object.

8. The computing system according to claim 1, wherein the processor is to reconfigure the specification of process for identifying the controlled object.

9. The computing system according to claim 8, wherein the processor is to reconfigure the specification of processes by modifying an order in which processes are evaluated, assigning and/or modifying weights indicative of a relative importance of the processes and/or omitting a process from the specification.

10. A non-transitory computer readable medium encoded with instructions which when executed by a processor, cause the processor to:
access a database that stores object data for a controlled object, the object data comprising:
confidentiality preserving descriptors associated to the controlled object; and
a specification of processes for identifying the controlled object, the specification comprising a hierarchical arrangement of processes into layers,
wherein processes in a given layer have a higher accuracy for identifying the controlled object than processes in a preceding layer; and
obtain an instruction to generate the three-dimensional object on the three- dimensional printing apparatus;
generate confidentiality preserving descriptors of the three-dimensional object; and
evaluate processes according to the object data for the controlled object based on the confidentiality preserving descriptors of the three-dimensional object and the controlled object.

11. The non-transitory computer readable medium according to claim 10, wherein the specification of processes comprises a discriminative band comparison process.

12. The non-transitory computer readable medium according to claim 10, wherein, to evaluate processes according to the object data, the instructions cause the processor to:
evaluate layers of the hierarchy of processes sequentially, based on an output of the evaluation of the preceding layer of processes in the hierarchy.

13. The non-transitory computer readable medium according to claim 12, wherein the output comprises a determination of whether the three-dimensional object is distinct from the controlled object.

14. The non-transitory computer readable medium according to claim 10, wherein the three-dimensional object is identified as being the same as the controlled object when evaluation of the processes across all layers of the hierarchy are indicative of a similarity between the three-dimensional object and the controlled object.

15. A method, comprising:
receiving a request to generate the three-dimensional object on a three- dimensional printing apparatus;
obtaining object data for a controlled object, the object data comprising:
confidentiality preserving descriptors associated to the controlled object;
and
a hierarchy of processes for identifying the controlled object, the hierarchy comprising layers of processes whereby processes in a given layer have a higher accuracy for identifying the controlled object than processes in a preceding layer; and
generating confidentiality preserving descriptors of the three-dimensional object; and
evaluating processes according to the object data for the controlled object based on the confidentiality preserving descriptors of the three-dimensional object and the controlled object.
